(19) United States
(12) Patent Application Publication
(10) Pub. No.: US 2018/0330327 A1
(43) Pub. Date: Nov. 15, 2018

(54) METHOD, SOFTWARE APPLICATION, AND SYSTEM FOR TRACKING ASSETS WITHIN A LOCATION

(71) Applicant: FuselT, LLC, Cincinnati, OH (US)

(72) Inventors: Daniel Dominic Hertenstein, Kansas City, MO (US); Josef Michael Hertenstein, Cincinnati, OH (US); Ronald Todd Thompson, Kearney, MO (US)

(21) Appl. No.: 15/977,139

(22) Filed: May 11, 2018

Related U.S. Application Data
(60) Provisional application No. 62/504,761, filed on May 11, 2017.

(51) Int. Cl. G06Q 10/10; G06Q 50/28; H04W 4/029

(52) U.S. Cl. CPC G06Q 10/10; H04W 4/029; G06Q 50/28

(57) ABSTRACT

The present disclosure includes an app provisioned with a geo-fencing policy, and the geo-fencing policy initializes once within a pre-defined geographical area. If the device is within the defined area, the app starts tracking a mobile unit. The geographical area, such as a building construction site, restaurant, or company campus, is defined using longitude and latitude coordinates and a location accuracy value. Device location is obtained using location/GPS services on the device, private network, or cellular tower triangulation. The app uses the location meta data to build reports, such as productivity, and hours on site to be compared with hourly billing, and also allows for notifications once a certain individual is within the geographical area—thus allowing for gathering of individuals to be easier.

This application claims priority to U.S. Provisional Application No. 62/504,761, filed on May 11, 2017 the entirety of which is incorporated herein by reference.

### BACKGROUND

The exemplary embodiments of this invention relate generally to devices and software, such as mobile computing and/or mobile communication devices, and more particularly, it relates to software on mobile devices utilizing data (such as location data) based on geographical location of the device and other location data.

A user's device can be any type of computing and/or communications device such as, but not limited to, a cell phone (e.g., a smartphone), a tablet computer, and a laptop computer. In some circumstances, a user is enabled or encouraged to bring the user's device into the user's work place environment and to use the device in the work place. Of course this scenario does not necessarily mean that the user must be physically present in the work place when using the device, since one may be able to connect such devices into the work place environment from a remote location such as from the user's home or from a customer location.

Modern portable consumer and industrial electronics, and especially client devices such as navigation systems, smartphones, portable digital assistants, and other smart mobile devices, are providing increasing levels of functionality to support modern life, including personalized information services. Research and development in the existing technologies can take a myriad of different directions.

There are many technological solutions to take advantage of with the vast amount of data generated by each person in the course of their daily lives. One existing approach is to use location information to provide navigation services such as a global positioning system (GPS) for a car or on a mobile device such as a smartphone.

There nevertheless exists a need for improving accountability of billing, knowledge of movement of assets, including people, within a work space and reporting on productivity.

Solutions to these problems have been long sought, but prior developments have not taught or suggested any fully acceptable solutions and, thus, solutions to these problems have long eluded those skilled in the art.

### SUMMARY

The following presents a simplified summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented elsewhere.

Novel and unobvious tracking asset systems and methods are set forth herein, as will be evident from reviewing the description below and the accompanying drawings.

Embodiments of the invention allow companies or businesses to connect to job site members (i.e., contractors, employees, etc.) for interactive, real-time coordination. The system creates a geographical fenced area to represent a work or job site and digitally stores all files and communication with shared schedules, real-time reporting of assets, and issue tracking in one secure location to allow for quick and easy access. The application may allot for changes in assets as assets (including employees) are moved from location to location (e.g., moving from shipment drop off to allocation of asset to work site). This tracking may allow for replenishment to be instantaneous with usage, and may allow for instantaneous audit. The tracking may further allow for comparison of efficiencies between employees, contractors, and management. In other embodiments, the tracking allows for comparisons of efficiencies between employees, contractors, and management in different climate conditions.

A tracking system enables participants to engage in their activities while being easily accessible to others and while tracking movement or use. Activities may include any work related activities such as, but not limited to, walking, cooking, installing, serving, and repairing. The tracking system only starts tracking with the occurrence of a particular type of event. Events can include, for example, walking in and out of a geo-fenced location, or a specific user (e.g., project manager or electrician) walking within the geo-fenced area. The tracking system may be implemented over a communications network such as a cellular network or a private wireless and/or wireline network. Examples of the latter include WiFi and WiMax networks.

In one embodiment, the communications network is entirely independent of the Internet. In another embodiment, the tracking system makes minimal use of the Internet, such that information may be encrypted. Also, the tracking system may enable users to be mobile during participation in the activities. Preferably, the tracking system has a location verification or determination feature, which is operable to permit or disallow tracking from the geo-fenced location.

According to certain embodiments, the tracking system may be provided as an application or add-on to a pre-existing communication or data service. Thus, the tracking service applications may be made available to customers of a pre-existing communication or data service. In still other embodiments, the tracking service may be established first and the communication service may be added later.

In one embodiment, a method includes: provisioning, by a computing device of a network, an application onto a mobile device; determining, by the computing device, a specific geographic area; enabling, by means of a security device, the mobile device access to specific information concerning each user within the specific geographic area; tracking, by the computing device, the mobile unit within the specific geographic area within a preselected location accuracy value and storing a tracked position as location data; and determining from the location data at least one logistical report. In one embodiment, access to the logistical reporting feature of the application is only available to a certain subset of users. In certain embodiments, the preselected location accuracy value is one of the following: 1 foot, 5 feet, 10 feet, and 100 feet.

In certain embodiments, the mobile device is within a cellular telephonic communication network over which at least one of the following may be made: telephonic calls, video conferencing, text message, photo and video sharing, and push to talk. In another embodiment, the services are provided by the computing device of the network. Such services may include displaying weather, whom is on site at any given moment, team including employees and management, asset tracking, peer to peer communication, issue tracking and resolution, file and document sharing, notification monitoring, calendar sharing, and work flow management.

In certain embodiments, the security device is at least one of a bar code, a quick response (QR) code, and a multi-dimensioned code.

In one embodiment, the computing device of the network includes at least one database. The database stores at least one of a work site profile and a plurality of services. The work site profile may include at least one of the following data: site locations, members within a specific site, member job descriptions, and member information. Member information may include at least one of the following: physical address, email address, video conference contact information, wire line telephone number, wireless telephone number, and billing information. The work site profile may include billing information of at least one member of a site location, such that a report can be created so as to review actual time spent on a site in relation to time billed by that member for work on the site.

In certain embodiments, the logistical report may include one of the following: efficiencies of different users within a specific geographic location, accuracy of hours billed for a user within the specific geographic location, and an auditing report based on usage of assets.

### BRIEF DESCRIPTION OF THE DRAWINGS

The drawings constitute a part of this specification and may include exemplary embodiments of the present invention and illustrate various objects and features thereof.

A further understanding of the invention may be had by reference to the accompanying drawings.

FIG. 1 illustrates a block diagram of the tracking system according to an embodiment of the present disclosure.

FIG. 2 illustrates a mobile device including at least one service.

FIG. 3 illustrates a specific geographic location surrounded by a geo-fence location tracking system having users and assets both within the geo-fence and outside the geo-fence.

FIG. 4 is a flow diagram of a method for providing tracking logistics service application on a communications network.

### DETAILED DESCRIPTION

Reference will now be made in detail to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein.

The disclosure includes software or computer instructions, commonly referred to as “apps,” that may be installed on a variety of mobile devices, such as smart phones, tablet computers, gaming devices, and portable computing devices. These apps may also be downloaded on to non-mobile devices, such as TVs, computers, automobiles, and other emerging smart device categories. Methods and systems described are not intended to be limited to operation on mobile devices. These device programs have proliferated and are now very prevalent. Currently, apps are typically written in either Java or C. The methods and systems described herein may be applied to apps written in either or to apps written in other languages for different platforms. Most apps, if not all, have to communicate with the mobile device's operating system to get a specific service that the app needs in order to perform its intended function, and this service is usually only available from the operating system. A common example of such a service used is GPS to get the location of the device which the app may need.

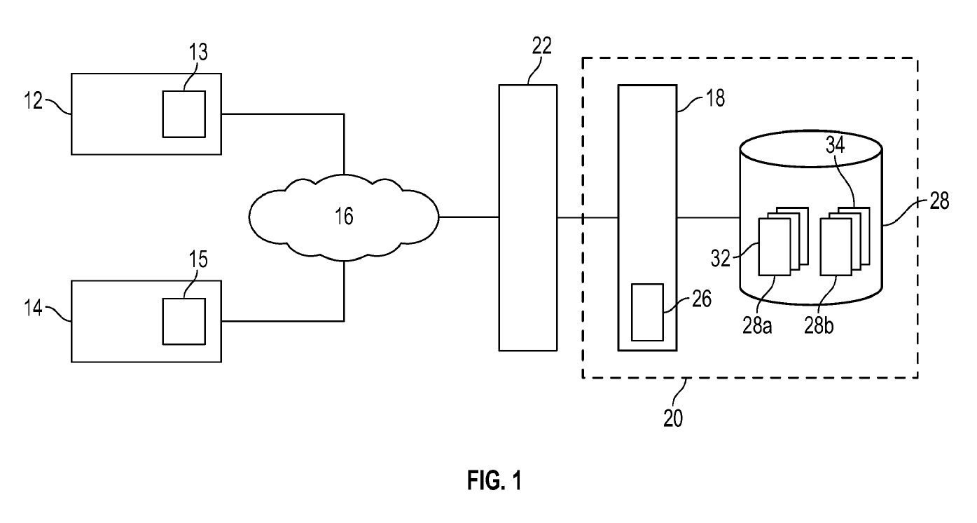

FIG. 1 is a block diagram of a tracking system 1 of the present disclosure. It is a generic description of one process without being tied to a specific configuration or environment. It may also be noted that the network 16 and connections between the components and software are shown generically. The tracking system 1 includes at least one user or asset 12. The system may include additional users such that there is at least a first user 12 and a second user 14. Multiple users may access tracking system 1, and/or other users may access a second tracking system in communication with first tracking system 1. Users 12 and 14 preferably access tracking system 1 by way of a mobile communication devices 13, 15. Mobile communication devices 13, 15 may comprise any suitable device for transmitting and receiving electronic communications. Examples of such devices include, without limitation, mobile phones, personal data assistants (PDAs), computers, mini-computers, etc. Mobile communication devices 13, 15 transmit location information and receive information or data to and from communications network 16. Location information is also transmitted between network 16 and a computer 18, such as a server, which may reside within the domain of a tracking service provider 20. An app 22 is provided by app or service provider 20 which can be any type of entity (individual, software developer, employer, etc.). An app 22 (also supplied by an app provider 20) is downloaded onto mobile device 13. The location of computer 18 is not critical, however, and computer 18 may reside adjacent to or remote from the domain of tracking service provider 20. The computer 18 and/or service provider 20 may reside within, adjacent to, or remote from a geo-location, geo-fence, or geo-area.

In another embodiment, the communications network 16 comprises a private wireless network. The private wireless network 16 may include, for example, an 802.11x (WiFi) or 802.16x (WiMax) technology. Also, a tracking system 1 may comprise a combination of networks 16 and may be interconnected. For example, a combination of private wireless networks 16, a cellular network comprising a multi-channel access unit or sectorized base station, and a satellite network comprising one or more satellites. With respect to the private wireless network 16, the technology covers smaller areas and provides very high-speed throughput, the private wireless network 16 is particularly well-suited for work site geo-locations.

The service provider 20 may be an actual controller of allocation of the software offered in the app. As an example, a service provider 20 may be located on the grounds of a geo-location and the computer 18 may be physically within the geographic boundaries of the service provider 20. Other possibilities exist for remote location of the computer 18 and the service provider 20. Computer 18 may function as an information server gathering information, such as tracking location data. Computer 18 may function as a security measure, such that personal information is protected. And additional computers may, for example, function as database management computers and redundant servers.

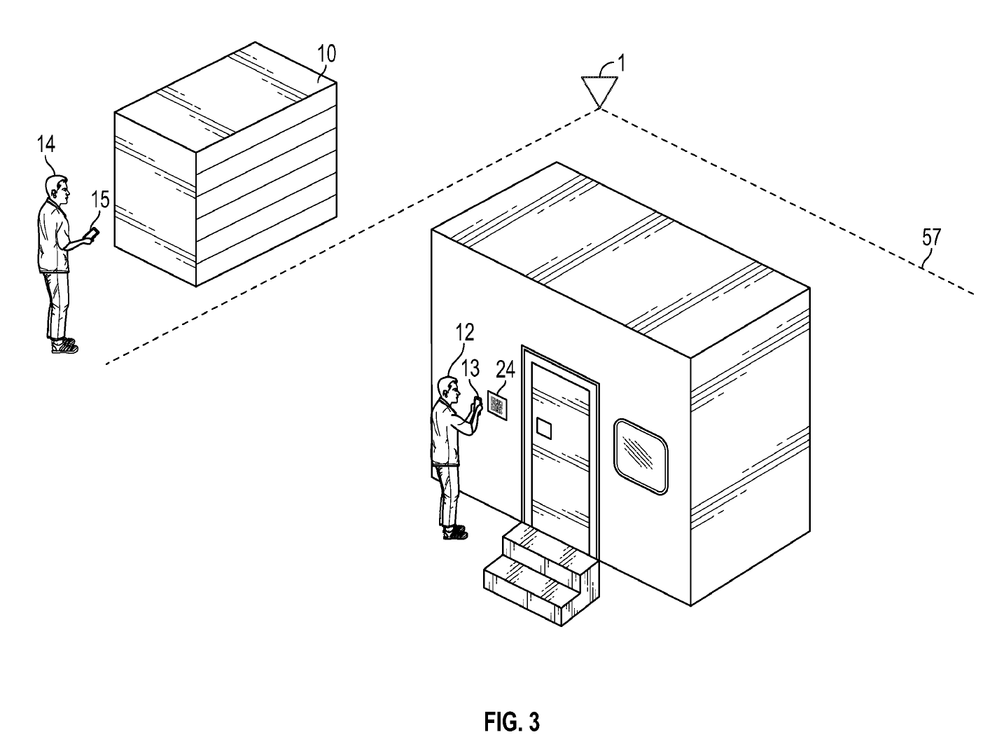

Preferably, software 22 resides on both the mobile communication device 13 and the computer 18. Once software or application 22 resident on mobile communication device 13 is operable to present information corresponding to a specific digital work place and activities therein, the software 22 may require a log-in as a security precaution. The software 22 on the service provider 20 may unlock personal information about users within a work site once a security device 24 (FIG. 3). Access to the software 22 to be installed on the mobile communication device 13 may be controlled or freely given. The specific work place information and all data concerning users may be secured by a security device 24, such as bare code, quick response (QR) code, or other multi-dimensioned code as a means for securing the information allotted at that specific site. Such information may include: weather 44, precipitation 46, cloud cover 48, whom is on site at any given moment, team of employees and management, asset tracking and/or reporting, peer to peer communication (push to talk, phone, email, messaging, video conferencing, etc.), job lists and order, issue tracking and resolution, file or document sharing, notification or alert monitoring, calendar and calendar sharing 50, work flow management and reporting 52, etc. The information includes, without limitation, graphical representations of assets associated with the activities (i.e. for example, lumber, ovens, or employees), and presentation of options related to the activities and selectable by the user. The weather 44 may be key in determining scheduling or re-scheduling of trades in a given time frame, i.e. hourly, day, week.

The software could have different features dependent upon the user type, for example an administrative user would have most if not all features and services unlocked to be used, whereas a standard user would get some features or services, such as the communication services, but not the reporting 52 services.

The mobile communication device software 22 is also preferably operable to receive data from the computer 18 and data input by the user 12, 14, such as via touch screen or keyboard. The software 22 may be ran within a web application, such as Internet Explorer, Chrome, or Safari, or ran as a mobile application (app) on iOS, Windows, Android, or other operating systems. Software or computer instructions 26 resident on the computer 18 in memory may preferably be able to exchange data with the mobile communication device 13, access additional computers and data storage devices, and perform all of the functions described herein as well as functions common to mobile communication devices. The computer 18 has at least one processor and database 28 to store data, such as computer instructions and/or location data. Such data may also be the profiles of each individual user 12, 14 that has been given access to the work site or place and their mobile devices allowing for the ability to be tracked via the software.

Preferably, tracking system 1 includes at least one database 28. The database(s) 28 may be any suitable database capable of receiving, storing, and/or distributing electronic data. In the illustrated embodiment of FIG. 1, tracking system 1 includes a work site profile database 28a and a services database 28b. One or more work site profiles 32 are maintained in work site profile database 28a. Each work site profile 32 preferably consists of one or more data files, such as site location, members within that site, members job descriptions, members information such as physical address, email address, video conference contact information (e.g., Skype account name), wire line telephone number, and wireless telephone number, billing information such as pay rate or per hour charge, and schedules for site and calendars for members, etc. It is generally recognized that in certain embodiments work site profiles 32 may include less or more information. The work site profiles 32 may be maintained in any form that allows the establishment, maintenance, and or updating of work site profiles 32 via the transfer of electronic information. It should also be understood that work site profile information may be centralized, as shown, or distributed and certain portions of customer profile information may be maintained at different elements within or without system.

In certain embodiments, work site profiles 32 also include billing information of a particular user 12, 14 that may be used to compare with a bill for services rendered during a billing period. The billing information can be utilized by the service provider 20 and computer 18 to determine how long that individual user 12, 14 was on site working to calculate fees and compare with the time billed in the bill received. Such a comparison can show much was billed versus how much was actually worked and an efficiency rating can be given to said contractor or employee.

As described above, tracking system 1 also includes a services database 28b. Service database 28b may include a library of service applications 34 offered to users 12, 14 and any service-specific information associated with service applications 34. Example service applications 34 include video or voice call applications, electronic mail applications, calendar application, or any other communication application provided to users 12,14 by service provider 20. In particular embodiments, service applications 34 may be downloaded to and stored in communication devices 13. Alternatively, service applications 34 may be stored centrally by service provider 20 and accessed by devices 13 as needed.

Additionally, although two databases 28a and 28b are illustrated in FIG. 1, it is generally recognized that tracking system 1 may include fewer or more databases 22 as appropriate. Accordingly, it is recognized that the information described above as being stored in work site database 28a and service application database 28b is not meant to be disclosed as mutually exclusive. Some or all of the information described as being stored in work site database 28a may be stored in service application database 28b or any other database within or without of service provider 20 and tracking system 1. Similarly, some or all of the information described as being stored in service application database 28b may be stored in work site database 29a or any other database.

Mobile information transmitted across network 16 may include any information or data, in any format, which is necessary or desirable in the operation of the tracking system 1 in which the user participates. The information may be transmitted in whole, or in combination, in any format including digital or analog, text or voice, and according to any known or future transport technologies, which may include, for example, wireline or wireless technologies. Wireless technologies may include, for example, licensed or license-exempt technologies. In particular embodiments, network 16 may include a Land Area Network (LAN), a Wide Area Network (WAN), a Metropolitan Area Network (MAN), a Personal Area Network (PAN), the Internet, an Intranet, an Extranet, or any combination of these or other suitable communication networks. Some specific technologies which may be used include, without limitation, Code Division Multiple Access (CDMA), Time Division Multiple Access (TDMA), Global System for Mobile Communication (GSM), General Packet Radio Service (GPRS), WiFi (802.11x), WiMax (802.16x), Public Switched Telephone Network (PSTN), Digital Subscriber Line (DSL), Integrated Services Digital Network (ISDN), Blue Tooth, or cable modem technologies. These are examples only and one of ordinary skill will understand that other types of communication techniques are within the scope of the present invention. Further, it will be understood that additional components may be used in the communication of information between the users 12, 14 and the server 18. Such additional components may include, without limitation, lines, trunks, antennas, switches, cables, transmitters, receivers, computers, routers, servers, fiber optical transmission equipment, repeaters, amplifiers, etc.

The location information may be specific to a single geo-location and gathered using location verification technology, which is discussed in greater detail below with regard to FIG. 3. It is foreseen that an administration or project manager may have access to several geo-locations or geo-fenced areas and can bring up information specific to that geo-location. Generally, location tracking technology may include, without limitation, “network-based” and/or “satellite-based” technology that allows for the disabling of certain service applications when outside the geo-location. Thus, in the examples described above, network-based technologies such as multilateration, triangulation and geo-fencing and/or satellite-based technologies such as global positioning satellite (GPS) may be used to identify the presence or absence of the users or assets 12, 14 in the geo-location.

As described above, the system 1 described in connection with FIG. 1 is merely an example of a tracking system 1 within a geo-location specific to the user 12, 14. It will be readily understood that system 1 may be modified in any number of ways within the scope and spirit of the detailed description. For example, although service provider 20 is described as providing both telecommunication and services, it is generally recognized that service provider 20 may provide only services through an application on the user mobile device 13.

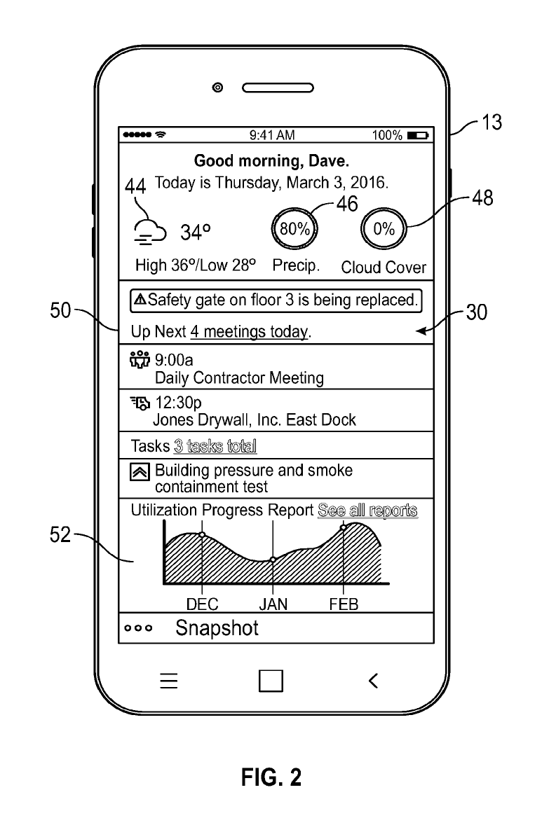

As shown in FIG. 2, certain embodiments of the tracking system 1 may include software 26 and hardware (e.g., processor, memory) to enable the offering of services 30 on pre-existing communication networks. Such communication services may include voice and/or data services. For example, service provider 20 may offer wireless telephone, push to talk, video, and/or messaging services to one or more customers through the internet or a network 16. Such services may include those similar to the wireless services provided by Sprint, AT&T, Verizon, T-Mobile, SBC, Nextel, and other mobile carriers. Such telecommunication services including cellular telephone, paging, text messaging, and other wireless services may be provided through computer 18 or another computer associated with service provider 20. It is generally recognized that the telecommunication services includes any type of communication or data delivery services, including, but not limited to those communication and data delivery services that may be communicated on CDMA, TDMA, GSM, GPRS, WiFi (802.11x), WiMax (802.16x), PSTN, DSL, ISDN, Blue Tooth, and/or cable modem technologies.

In particular embodiments, services 30 may be made available to all users of service provider 20 or to only those within the geo-location, or as another example, access may be specific to the role of the user 12, 14.

As shown in FIG. 3, the tracking system 1 includes a plurality of assets 10, 12, and 14. Device 15 is located inside the geo-fenced area 40. Assets 10 and 14 are both located outside the geo-fenced area 40. Thus, geo-fencing may be used to track device 13 but not assets 10, 14. It is foreseen that even though some communication devices are within the geo-fenced area 40, they are not permitted access to the system 1 until after the bar code 24 has been scanned enabling use. Thus, users 12, 14 receiving telecommunication services such as cellular service may be offered access to all services 30 from applications 22 offered by service provider 20 or only a subset. For example, only an administrator, project head, or manager would be given access to certain reporting 52 features, such as billing and reporting information.

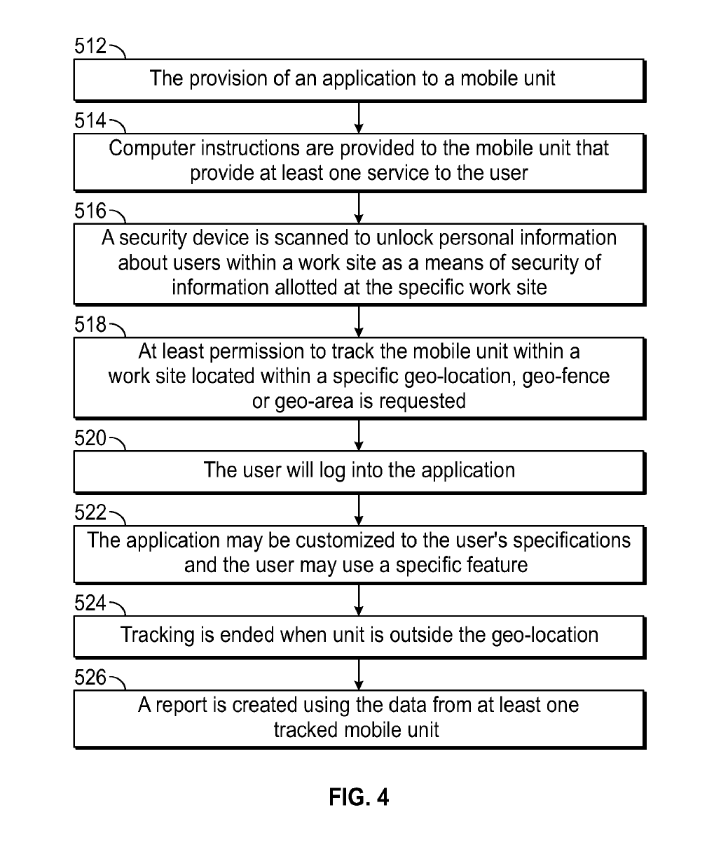

FIG. 4 illustrates an example method 500 for providing tracking logistics service application on a communications network. The method begins at step 512 with the provision of an application to a mobile unit 13. There are several examples of operating systems for mobile units 13, such as iOS (for the iPhone), Android (used on handsets from various manufacturers), Windows Mobile 7, Web O/S, Palm, and others. At step 512, the core object code app may decompile to obtain the executable object code. For example, it can be either “native code” (CPU instructions) or bytecode (virtual machine instructions, such as Java or .Net). In one embodiment, an enterprise may have its own app store for its employees, partners, and the like, where users can only download the app. Software is preferably loaded on a mobile communication device 13 and is operable to receive input and send location data. The input data may originate at associated software resident on the server 18, or it may be input by the user of the communication device 13.

As described above, in particular embodiments, the communications service may be provided on a pre-existing tracking network to a user 12, 14. For example, in certain embodiments, the tracking service may include a Global Positioning Satellite (GPS), cellular tower network triangulation, channel address checking, or location verification using some other identifying number or piece of information indicative of which network or portion of a network is being accessed by the communication device 13.

At step 514 computer instructions are provided to the mobile unit 13 that provide at least one service to the user 12, 14. As explained above the service may be dependent upon the type of user 12, 14.

At step 516, a QR code, multidimensional code, or bare code is scanned to unlock personal information about users within a work site as a means of security of information allotted at the specific work site.

At step 518, is at least permission to track the mobile unit 13 within a work site located within a specific geo-location, geo-fence or geo-area. This means that the application or computer instructions will not track outside of a given geo-location. Once within the boundaries of the geo-location, the tracking system 1 will periodically on a set time interval update the location determination information and such information will be stored in the server 18.

At step 520, the user 12, 14 will log into the application. The mobile communication device 13 is activated. This may also take place as a function of turning on a phone, PDA, or other communication device 13. A second level of user authentication may comprise biometrics. Various examples of biometrics may include, but are not limited to, fingerprint identification, photo identification, retina scanning, voice print matching, etc. The software resident on the communication device 13 may incorporate functionality that will, upon login or access by the user, determine the user's location (based at least in part on the identifying information) and send location data to the service provider 20 and/or server 18. Certain features may only become available once within the geo-location.

At step 522, the application may be customized to the user's specifications and the user 12, 14 may use a specific feature or service. Such customization may include what is on the “home” page of the application, the user 12, 14 may decide that weather 44 at each location that has been unlocked is relevant and important to know, as this may affect the daily routine at the work site. Notifications or alerts can be set, such as when a given user 12, 14 arrives on site, how long that user 12, 14 is out of the geo-location, or if the user is out of range of the geo-location. Reports can be readily available, such as billing, arrival of certain users 12, 14 in relation to their expected time or date of arrival (i.e. project management milestones). Certain users 12, 14 may be on the home screen to instantly dial, email, push to talk, video conference, etc.

At step 524, tracking is ended when the unit is outside the geo-location. The parameters to define a geographical area, such as a building or work site campus, in which the app will execute on the device, within a certain margin of error, such as 10, 100, or 1000 meters. If the device is outside the defined area, the app will not execute, again taking into consideration a margin of error. When defining the area during geo-fencing provisioning, the latitude and longitude coordinates and a location accuracy value are set. The device location is obtained using location services on the device which typically also have a location accuracy value. In this manner a centralized policy to control and secure data is implemented on the device.

At step 526, a report is created using the data from at least one tracked mobile unit. Reports include the accountability of billing, knowledge of movement of assets including people within a work space and productivity of those assets including people.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention. Further, it will be understood that certain features and subcombinations may be of utility and may be employed within the scope of the disclosure. Further, various steps set forth herein may be carried out in orders that differ from those set forth herein without departing from the scope of the present methods. This description shall not be restricted to the above embodiments. It is to be understood that while certain forms of the present invention have been illustrated and described herein, it is not to be limited to the specific forms or arrangement of parts described and shown.

1. A method comprising:
provisioning, by a computing device of a network, an application onto a mobile device;
determining, by the computing device, a specific geographic area;
enabling, by means of a security device, the mobile device access to specific information concerning each user within the specific geographic area;
tracking, by the computing device, said mobile unit within said specific geographic area within a preselected location accuracy value and storing a tracked position as location data; and
determining from the location data at least one logistical report.

2. The method of claim 1, wherein the mobile device is within a cellular telephonic communication network over which at least one item selected from the group consisting of the following may be made: telephonic calls, video conferencing, text message, photo and video sharing, and push to talk.

3. The method of claim 1, wherein the security device is at least one item selected from the group consisting of a bar code, a quick response (QR) code, and a multi-dimensioned code.

4. The method of claim 1, wherein only a subset of users may access the at least one logistical report.

5. The method of claim 1, further comprising the step of providing, by the computing device, at least one service.

6. The method of claim 5, wherein the at least one service is at least one item selected from the group consisting of the following: weather, whom is on site at any given moment, team including employees and management, asset tracking, peer to peer communication, issue tracking and resolution, file and document sharing, notification monitoring, calendar sharing, and work flow management.

7. The method of claim 1, wherein the computing device of the network includes at least one database.

8. The method of claim 7, wherein the database stores at least one of a work site profile and a plurality of services.

9. The method of claim 8, wherein:
the work site profile includes at least one item selected from the group consisting of the following data: site location, members within a specific site, member job descriptions, and member information; and
the member information includes at least one item selected from the group consisting of the following: physical address, email address, video conference contact information, wire line telephone number, and wireless telephone number, and billing information.

10. The method of claim 8, wherein the work site profile includes billing information of at least one member of a site location, such that a report can be created so as to review actual time spent on a site in relation to time billed by a respective member for work on the site.

11. The method of claim 1, wherein the logistical report includes at least one item selected from the group consisting of the following: efficiencies of different users within a specific geographic location, accuracy of hours billed for a user within the specific geographic location, and an auditing report based on usage of assets.

12. The method of claim 1, wherein the preselected location accuracy value is one of the following: 1 foot, 5 feet, 10 feet, and 100 feet.

13. The method of claim 5, further comprising requiring a respective user to log in before providing the at least one service to the respective user.
